(19) United States
(12) Patent Application Publication
(10) Pub. No.: US 2024/0316879 A1
(43) Pub. Date: Sep. 26, 2024

(54) IMPREGNATING COATING LAYER FOR INSULATING SHEETS

(71) Applicants: DUPONT SAFETY & CONSTRUCTION, INC., Wilmington, DE (US); COVEME S.P.A., Gorizia (IT)

(72) Inventors: Benjamin Gaussens, Meyrin (CH); Giorgio Patrizio Vercesi, Meyrin (CH); Luigi D'Arco, Gorizia (IT)

(21) Appl. No.: 18/578,628

(22) PCT Filed: Jul. 18, 2022
(86) PCT No.: PCT/US2022/073825

§ 371 Date: Jan. 11, 2024

(30) Foreign Application Priority Data
Jul. 19, 2021 (IT) 102021000018965

(51) Int. Cl. B29C 70/18; B29C 70/50; B29K 279/00; B29K 309/10; B29L 31/00; B29L 31/34

(52) U.S. Cl. CPC B29C 70/18; B29C 70/50; B29K 2279/085; B29K 2309/10; B29K 2995/0097; B29L 2031/3412; B29L 2031/749

(57) ABSTRACT

The present invention relates to an insulating sheet of a nonwoven sheet, for example a sheet comprising aramid fiber, comprising 15 to 80 percent by weight of a crystalline silicate mineral powder, for example a mica powder, the nonwoven sheet impregnated with a coating of an impregnating resin based on acrylate derivatives, which is suitable for increasing the compactness of the insulating sheet and for preventing the silicate mineral powder from detaching from the nonwoven sheet during use. The impregnating resin also comprises an organic solvent, which is capable of reducing the viscosity thereof and of promoting its deep penetration into the sheet. In addition, the impregnating resin comprises a UV polymerization photoinitiator which is suitable for curing the resin, only after said resin has been applied to the sheet and has penetrated deeply therein. The invention also describes the method for impregnating the insulating sheets.

### TECHNICAL FIELD

The present invention relates to the field of producing impregnated insulating coating layers. In particular, the present invention relates to impregnated coating layers including nonwoven sheets containing crystalline silicate mineral powder such as aramid/mica electrical insulators. Even more particularly, the present invention relates to impregnated coating layers made of acrylate resin, for aramid/mica electrical insulators.

### PRIOR ART

In recent years, with the rapid development of electrical machines, more and more attention has been paid to materials which have excellent insulating properties and high mechanical properties under extreme working conditions. For example, aramid/mica sheets are used for electrically insulating motors.

Mica has excellent physical, electrical and thermal properties and has high stability and adaptability even at high temperatures; however, it has poor mechanical strength and thus cannot be used directly for making insulating sheets. Mica may advantageously be added to aramid sheets to impart greater resistance to partial discharge to said sheets.

One of the major problems for the production of aramid/mica insulating sheets is that when mica is introduced into the aramid paper structure, it is sparingly cohesive and tends to become detached. The surface of the aramid/mica paper is thus dusty and difficult to laminate and to impregnate with epoxy and polyester resins, or to use as an insulator in a rotating or static electrical machine.

In order to improve the properties of aramid/mica paper, some studies known in the prior art propose the introduction of adhesive layers to increase the surface bonding between the aramid fibers and the mica.

For example, US 2014/0 028 140 A1 describes an aramid/mica tape wrapped around a rotating coil for the purpose of giving it electrical insulation with respect to the exterior. The aramid/mica tape also has a layer of an adhesive resin containing acryloyl-based compounds, which is used for improving the adhesion between the mica and the aramid. However, the adhesive resin layer is applied to the already-formed aramid/mica paper and therefore does not penetrate deeply therein. Thus, the compactness of the aramid/mica sheets is only partially increased.

US 2021/0 062 429 A1, for its part, proposes an alternative method for improving the mechanical properties of aramid/mica sheets, based on the use of aramid nanofibers instead of aramid microfibers, to be incorporated into an insulating sheet containing mica. In this manner, the surface area of interaction between the aramid and the mica is increased and the compactness of the aramid/mica sheets is promoted. However, the process described in US 2021/0 062 429 A1 for making aramid nanofibers is complex, laborious and thus expensive.

### SUMMARY

In the light of the abovementioned problems and drawbacks related to the production of insulating sheets, one of the objects of the present invention is to provide insulating sheets comprising a nonwoven sheet, for example an aramid paper, containing a crystalline silicate mineral powder, for example mica, characterized by high surface cohesion and a compact surface. For example, one of the objects of the present invention is to provide aramid/mica insulating sheets, in which the mica particles are stably attached to the aramid fibers, so that they do not become detached during use.

According to one embodiment of the present invention, an insulating sheet comprising a nonwoven sheet containing a crystalline silicate mineral powder is provided, characterized in that the nonwoven sheet contains 15 to 80 percent by weight of the crystalline silicate mineral powder, and the insulating sheet also comprises a coating of an impregnating resin based on acrylate derivatives.

This configuration is particularly advantageous in that the insulating sheets comprising a nonwoven sheet containing a crystalline silicate mineral powder are impregnated with a layer of coating resin, which is capable of penetrating deep into the insulating sheets and thus of improving their compactness.

Preferably, the nonwoven sheet comprises aramid paper. Aramid paper is advantageously used since aramid is a material characterized by high dielectric strength, excellent mechanical capacities, such as flexibility and resilience, and high thermal stability.

Preferably, the crystalline silicate mineral powder comprises mica.

According to a preferred configuration, aramid/mica insulating sheets are provided, in which the surface of the sheets is coated with a low-viscosity acrylate resin, for example a resin with a viscosity of between 5 cps and 150 cps, preferably equal to 10 cps. By virtue of the low viscosity, the penetration of the resin into the sheet is promoted, so that the impregnating resin layer has, for example, a thickness of at least 5 μm, preferably at least 10 μm, even more preferably at least 15 μm, in aramid sheets having a thickness of between 0.08 mm and 0.15 mm, and a thickness of at least 15 μm, preferably of at least 40 μm, in aramid sheets having a thickness of between 0.2 mm and 0.25 mm.

According to a further embodiment of the present invention, an insulating sheet is provided, in which the crystalline silicate mineral powder comprises mica.

This configuration is advantageous since mica can be used as an additive for increasing the partial discharge resistance. The reason for this is that mica is characterized by unique physical, thermal and electrical properties and high stability, resilience and adaptability.

According to a preferred configuration, an insulating sheet comprising aramid and mica is provided. In point of fact, an aramid paper which includes a certain amount of mica in its structure is characterized by higher resistance to partial discharge than an aramid paper free of additives.

According to one embodiment, the insulating sheet comprises a nonwoven sheet having a first surface and a second surface, the nonwoven sheet comprising 15 to 80 weight percent crystalline silicate mineral powder, 5 to 25 weight percent heat-resistant floc, and 20 to 60 weight percent binder, based on the total amount of said crystalline silicate mineral powder, floc, and binder in the nonwoven sheet, wherein each of the first and second surfaces of the nonwoven sheet are coated with the impregnating resin, and each of the first and second surfaces are stabilized by a region of the said impregnating resin that both covers and extends into each of said first and second surfaces. The region of impregnating resin extends into the sheet a distance of 10 to 50 micrometers from each of said first and second surfaces, and further, the region of impregnating resin has a thickness of impregnating resin of from 5 to 50 micrometers on each of said first and second surfaces. In some embodiments, the region of impregnating resin has a thickness of impregnating resin on each of said first and second surfaces of from 5 to 25 micrometers. Preferably the crystalline silicate mineral powder is mica.

In some preferred embodiments the insulating sheet has a thermal conductivity of greater than 0.18 Watts per meter-Kelvin, as measured per ASTM D5470.

According to one embodiment, the insulating sheet has a total thickness of 0.10 to 0.4 millimeters, and in another embodiment the insulating sheet has a total thickness of 0.15 to 0.35 millimeters.

In some embodiments, the nonwoven sheet of the insulating sheet comprises 20 to 70 weight percent mica. In some other embodiments, the nonwoven sheet of the insulating sheet comprises 30 to 60 weight percent mica.

According to a preferred embodiment, the insulating sheet comprises heat-resistant floc, preferably aramid floc; and the preferred aramid floc is poly (metaphenylene isophthalamide) floc. In some preferred embodiments, the insulating sheet comprises a binder, preferably a binder of aramid fibrids; and the preferred aramid fibrids are poly (metaphenylene isophthalamide) fibrids.

According to a further embodiment of the present invention, an insulating sheet is provided, in which the coating comprises a compound of acrylate monomers and of acrylate oligomers.

The advantage of this configuration is that a compound of acrylate monomers with acrylate oligomers is characterized by high mobility and a low molecular weight, for example, a molecular weight of between 200 daltons and 500 daltons, and thus is capable of penetrating through the porosity of the insulating sheet.

According to a preferred configuration, an insulating sheet comprising aramid and mica is provided and is characterized by a coating of a resin composed of acrylate monomers and acrylate oligomers. The acrylate compounds penetrate into the aramid/mica paper, compacting and permanently fixing the mica powder in the aramid paper structure.

According to a further embodiment of the present invention, an insulating sheet is provided, in which the acrylate monomers are bifunctional or trifunctional methacrylates, for example 1,6-hexanediol diacrylate (HDDA), dipropylene glycol diacrylate (DPGDA), butanediol dimethacrylate (BDMA), neopentyl glycol diacrylate (NPGDA), isobornyl acrylate (IBOA), hydroxyethyl methacrylate (HEMA), hydroxyethyl acrylate (HEA), trimethylolpropane triacrylate (TMPTA), pentaerythrityl triacrylate (PETIA), tetramethylene dimethacrylate, hexanediol dimethacrylate, propoxylates and/or ethoxylates.

Mono-, di- or tri-functional acrylate monomers are particularly advantageous since they increase the bond density of the polymerization product.

According to a further embodiment of the present invention, an insulating sheet is provided, in which the acrylate oligomers are urethane acrylate, epoxy acrylate and/or polyester acrylate.

According to a further embodiment of the present invention, an insulating sheet is provided, in which the impregnating resin coating comprises an unsaturated polyester imide material.

This configuration is particularly advantageous since the polyester imide resin is capable of penetrating deeply into the matrix of the insulating sheet, avoiding any possibility of dust shedding and falling off, thereby improving the processability of the insulating material. Furthermore, it is possible to transform this polyester imide resin, normally used for impregnating electric motors, from a thermosetting coating to a UV-polymerizable coating by simply adding a photoinitiator to the resin mixture.

According to a further embodiment of the present invention, an insulating sheet is provided, in which the impregnating resin also comprises a polymerization photoinitiator, in particular a UV polymerization photoinitiator.

Nonlimiting examples of photoinitiators used in the present invention include Omnirad TPO-L, 2-hydroxy-2-methyl-1-phenylpropanone, diphenyl-2,4,6-trimethylbenzoylphosphine oxide (TPO), phosphine oxide (BAPO), phenylbis(2,4,6-trimethylbenzoyl)phosphine oxide (BAPO), 1-hydroxycyclohexyl phenyl ketone (HCPK), 2-hydroxy-2-methyl-1-phenyl-1-propanone (HMPP), or the photoinitiators belonging to the class of bi-acyl phosphate oxide polymers (TPO), or the photoinitiators belonging to the class of α-hydroxy ketones.

The advantage of this configuration is that the polymerization of the impregnating resin takes place after applying the resin to the insulating sheet and following exposure to UV light. In this manner, the impregnating resin can penetrate deep into the insulating paper and can compact it, preventing, for example, the detachment and shedding of mica in the subsequent processing steps.

According to a further embodiment of the present invention, an insulating paper is provided, in which the impregnating resin also comprises an organic solvent, for example methyl ethyl ketone.

The advantage of this configuration is that the viscosity of the impregnating resin is lowered. According to a preferred configuration, the impregnating resin comprises methyl ethyl ketone (MEK), which is an organic solvent characterized by a high evaporation rate and which is widely used in acrylic and polyurethane paint and coating thinners, to lower their viscosity.

According to a further embodiment of the present invention, an insulating sheet comprising an amount of impregnating resin based on acrylate derivatives comprised between 1 g and 10 g per square meter of insulating sheet is provided.

According to a further embodiment of the present invention, a method is provided for producing an insulating sheet, comprising the following steps:
a) provision of a nonwoven backing sheet comprising 15 to 80 percent by weight of a crystalline silicate mineral powder, for example mica;
b) depositing a coating layer of an impregnating resin based on acrylate derivatives onto the backing sheet so as to obtain a resin-impregnated sheet.

This configuration is particularly advantageous since the backing sheet, for example made of aramid paper containing mica, is impregnated with a coating resin layer that is capable of penetrating deep into the matrix. In this manner, the mica is prevented from becoming detached from the aramid paper following exposure to various mechanical stresses during implementation processes, but the electrical properties of the aramid/mica paper are not affected. In particular, aramid/mica sheets are characterized by higher resistance to partial discharge than aramid sheets.

The method of the present invention thus makes it possible to simplify the subsequent processing and lamination of aramid/mica insulating sheets and to facilitate their use as insulating materials for insertion, for example, in the stator slots of electric motors.

Preferably, the aramid/mica backing sheets are supplied on reels and the impregnating resin is applied to the sheets by means of a “roll to roll” process.

According to one embodiment, the method comprises a nonwoven backing sheet having a first surface and a second surface, the nonwoven backing sheet comprising 15 to 80 weight percent crystalline silicate mineral powder, 5 to 25 weight percent heat-resistant floc, and 20 to 60 weight percent binder, based on the total amount of said crystalline silicate mineral powder, floc, and binder in the nonwoven backing sheet, and wherein the coating layer of impregnating resin is deposited on each of the first and second surfaces of the nonwoven backing sheet. The coating layer provides a region of the said impregnating resin that both covers and extends into each of said first and second surfaces. The region of impregnating resin extends into the nonwoven backing sheet a distance of 10 to 50 micrometers from each of said first and second surfaces, and further, the region of impregnating resin has a thickness of impregnating resin of from 5 to 50 micrometers on each of said first and second surfaces. In some embodiments, the region of impregnating resin has a thickness of impregnating resin on each of said first and second surfaces of from 5 to 25 micrometers. Preferably, the crystalline silicate mineral powder is mica.

In some embodiments of the method, the nonwoven sheet of the insulating sheet comprises 20 to 70 weight percent mica. In some other embodiments, the nonwoven sheet of the insulating sheet comprises 30 to 60 weight percent mica.

According to a preferred embodiment of the method, the insulating sheet comprises heat-resistant floc, preferably aramid floc; and the preferred aramid floc is poly (metaphenylene isophthalamide) floc. In some preferred embodiments, the insulating sheet comprises a binder, preferably a binder of aramid fibrids; and the preferred aramid fibrids are poly (metaphenylene isophthalamide) fibrids.

According to a further embodiment of the present invention, a method is provided for producing an insulating sheet, in which the coating layer comprises a compound of acrylate monomers and of acrylate oligomers.

The advantage of this configuration is that a compound of acrylate monomers with acrylate oligomers is characterized by high mobility and a low molecular weight, for example a molecular weight of between 200 daltons and 500 daltons and is thus capable of penetrating the porosity of the insulating sheet.

In particular, acrylate compounds are capable of penetrating deep into the aramid/mica paper, compacting and permanently fixing the mica powder into the structure of the aramid paper.

According to a further embodiment of the present invention, a method is provided for the production of an insulating sheet, in which the acrylate monomers are bifunctional or trifunctional methacrylates, for example 1,6-hexanediol diacrylate (HDDA), dipropylene glycol diacrylate (DPGDA), butanediol dimethacrylate (BDMA), neopentyl glycol diacrylate (NPGDA), isobornyl acrylate (IBOA), hydroxyethyl methacrylate (HEMA), hydroxyethyl acrylate (HEA), trimethylolpropane triacrylate (TMPTA), pentaerythrityl triacrylate (PETIA), tetramethylene dimethacrylate, hexanediol dimethacrylate, propoxylates and/or ethoxylates.

According to a further embodiment of the present invention, a method is provided for producing an insulating sheet, in which the acrylate oligomers are urethane acrylate, epoxy acrylate and/or polyester acrylate.

According to a further embodiment of the present invention, a method is provided for producing an insulating sheet, in which the coating layer comprises an unsaturated polyester imide material.

This configuration is particularly advantageous since the polyester imide resin is capable of penetrating deep into the matrix of the insulating sheet, avoiding any possibility of dust shedding and falling off, thereby improving the processability of the insulating material. In addition, it is possible to transform this polyester imide resin, normally used for impregnating electric motors, into a UV-polymerizable coating by adding a photoinitiator to the resin mixture.

According to a further embodiment of the present invention, a method is provided for producing an insulating sheet, in which the coating layer comprises an organic solvent and the method also comprises the following step:
c) evaporation of the organic solvent by drying the resin-impregnated sheet.

The advantage of this configuration is that an organic solvent, for example, methyl ethyl ketone, is added to the coating formulation for the purpose of improving the deep penetration of the acrylate oligomers and monomers. The organic solvent is used as an unreactive diluent for the purpose of reducing the viscosity of the coating formulation, to allow the application of the wet coating by means of rotogravure and thus obtain a uniform and homogeneous surface. When the coating resin has penetrated into the backing sheet, the organic solvent is evaporated off.

According to a further embodiment of the present invention, a method is provided for producing an insulating sheet, in which the impregnating resin also comprises a polymerization photoinitiator, in particular a UV polymerization photoinitiator, for example Omnirad TPO-L or 2-hydroxy-2-methyl-1-phenylpropanone, and in which the method also comprises the following step:
d) exposing the resin-impregnated sheet to UV radiation to bring about the polymerization of the coating layer.

The advantage of this configuration is that polymerization of the impregnating resin takes place after applying the resin to the insulating sheet and following exposure to UV light. In this manner, the impregnating resin can penetrate deep into the insulating paper and can compact it, preventing, for example, the detachment and shedding of mica in the subsequent processing steps.

Preferably, the UV polymerization process is induced by exposure to an ultraviolet lamp, preferably having a wavelength in the range between 200 nm and 400 nm, whose emissions are concentrated on the substrate onto which a liquid formulation containing the photoinitiator has been applied. Following the UV light irradiation, radicals are generated that interact with the impregnating resin, bringing about polymerization and crosslinking of the formulation, which changes from liquid to solid.

The aramid/mica paper thus impregnated may advantageously be used, for example, in the construction of electric motors, as a secondary insulator (slot insulator).

According to a further embodiment of the present invention, a laminate is provided comprising at least one insulating sheet such as those described above and at least one plastic film layer, in which the insulating sheet is laminated onto one side of the plastic film layer, preferably so as to form the outer side of the laminate.

This configuration is particularly advantageous since the combination of at least one aramid paper insulating sheet and at least one plastic film layer makes it possible to obtain an insulating laminate which has physical, dielectric, thermal and mechanical properties that can be adapted to the user's needs.

Preferably, the various layers of aramid sheets and plastic film adhere to each other by means of suitable adhesives.

According to a preferred configuration, a laminate is provided comprising an insulating sheet of aramid paper that is adhered firmly to one or both faces of a layer of plastic film, so that this insulating sheet forms the outer layer of the laminate. The outer layer of the laminate refers to the layer that is in contact with the external environment.

According to a further preferred configuration, a laminate is provided comprising several layers of plastic film alternating with aramid paper insulating sheets, in which said insulating sheet forms at least one outer layer of the laminate. For example, the laminate may comprise alternating layers of plastic film and of insulating paper sheets, and may have one outer side formed by an aramid paper sheet and one outer side formed by a plastic film layer, or it may have both outer sides formed by aramid paper sheets.

According to a further preferred configuration, a laminate is provided comprising one or more layers of plastic film and one or more insulating sheets of aramid paper laminated together in any order, in which said insulating sheet forms at least one outer layer of the laminate. For example, the laminate may comprise one or more layers of plastic film and of insulating paper sheets laminated together in any order, and may have an outer side formed by an aramid paper sheet and an outer side formed by a plastic film layer, or it may have both outer sides formed by aramid paper sheets.

According to a further embodiment of the present invention, a laminate such as that described above is provided, comprising a plurality of insulating sheets and a plurality of plastic film layers, in which the insulating sheets are alternated with the plastic film layers, preferably so as to form the outer side of said laminate.

This configuration is particularly advantageous since the combination of a plurality of insulating sheets of aramid paper and a plurality of layers of plastic film makes it possible to obtain an insulating laminate which has physical, dielectric, thermal and mechanical features that can be adapted to the user's needs.

Preferably, the various layers of aramid sheets and of plastic film adhere to each other by means of suitable adhesives.

According to a further embodiment of the present invention, an electric motor is provided comprising one or more insulating sheets such as those described above or one or more laminated insulating sheets such as those described above.

This configuration is particularly advantageous since it is possible to insulate the phases from the stator of the electric motor by means of insulating sheets characterized by high resistance to partial discharge and having excellent mechanical properties even under extreme working conditions, for example at high voltages or during exposure to mechanical stresses.

### BRIEF DESCRIPTION OF THE FIGURES

The present invention will be described with reference to the attached figures in which the same numbers and/or reference marks indicate the same and/or similar and/or corresponding parts of the system.

FIG. 1 schematically shows an aramid/mica insulating sheet used as an insulating coating for the stator slots of an electric motor.

FIG. 2 schematically shows the process for producing aramid/mica insulating sheets also comprising a coating resin layer, according to one embodiment of the present invention.

### DETAILED DESCRIPTION

In the text hereinbelow, the present invention is described with reference to particular embodiments as illustrated in the attached figures. However, the present invention is not limited to the particular embodiments described in the following detailed description and represented in the figures, but rather the described embodiments simply exemplify the various aspects of the present invention, the scope of which is defined by the claims. Further modifications and variations of the present invention will emerge clearly to a person skilled in the art.

The present invention relates to an insulating sheet of a nonwoven sheet 10 comprising a crystalline silicate mineral powder, in particular mica, impregnated with a coating of a resin based on acrylate derivatives which penetrates deep into the sheet itself. By nonwoven sheet, it is meant a sheet structure produced by bonding and/or interlocking of fibrous material into a random web or mat by mechanical, chemical, or thermal methods, and combinations thereof. One preferred type of nonwoven sheet is a paper.

Preferably the nonwoven sheet is an aramid paper comprising aramid floc, aramid fibrids, or mixtures thereof. The aramid paper preferably contains meta-aramid fibrids as a binder along with aramid fiber or other thermostable floc or fiber or mixtures of such flocs or fibers. By thermostable it is meant that the given floc or fiber can withstand a long exposure to the end-use temperature without significant degradation (usually, to remain at least 50% of its initial properties after exposure for 100,000 hours to the necessary temperature, which in some instances is greater than 180° C.).

The term “aramid”, as used herein, means aromatic polyamide, wherein at least 85% of the amide (—CONH—) linkages are attached directly to two aromatic rings. Optionally, additives can be used with the aramid and may be dispersed throughout the polymer structure. It has been found that up to as much as about 10 percent by weight of other polymeric material can be blended with the aramid. It has also been found that copolymers can be used having as much as about 10 percent of other diamines substituted for the diamine of the aramid or as much as about 10 percent of other diacid chlorides substituted for the diacid chloride of the aramid.

The preferred aramid is a meta-aramid. The aramid polymer is considered a meta-aramid when the two rings or radicals are meta oriented with respect to each other along the molecular chain. The preferred meta-aramid is poly(meta-phenylene isophthalamide)(MPD-I). U.S. Pat. Nos. 3,063,966; 3,227,793; 3,287,324; 3,414,645; and 5,667,743 are illustrative of useful methods for making aramid fibers that could be used to make aramid floc.

The preferred aramid floc is a meta-aramid floc, and especially preferred is floc made from the meta-aramid poly(meta-phenylene isophthalamide)(MPD-I). The term “floc”, as used herein, means fibers that are cut to a short length and that are customarily used in the preparation of papers. Typically, floc has a length of from about 3 to about 20 millimeters. A preferred length is from about 3 to about 7 millimeters. Floc is normally produced by cutting continuous fibers into the required lengths using well-known methods in the art.

The term “fibrids”, as used herein, means very small, nongranular, fibrous or film-like particles with at least one of their three dimensions being of minor magnitude relative to the largest dimension. These particles are prepared by precipitation of a solution of polymeric material using a non-solvent under high shear. Aramid fibrids are non-granular film-like particles of aromatic polyamide having a melting point or decomposition point above 320° C. The preferred aramid fibrid is a meta-aramid fibrid, and especially preferred are fibrids made from the meta-aramid poly(meta-phenylene isophthalamide)(MPD-I). Fibrids generally have a largest dimension length in the range of about 0.1 mm to about 1 mm with a length-to-width aspect ratio of about 5:1 to about 10:1. The thickness dimension is on the order of a fraction of a micron, for example, about 0.1 microns to about 1.0 micron. While not required, it is preferred to incorporate aramid fibrids into the layers while the fibrids are in a never-dried state.

By aramid paper, as used herein, it is meant a planar sheet made from one or more plies or layers of aramid materials that are prepared by paper-making processes. Representative devices and machinery that can be used to make plies or layers include continuous-processing equipment such as, for example without limitation to, a Fourdrinier or inclined wire machine, or batch-processing equipment such as those that make paper by hand in a hand-sheet mold containing a forming screen.

To make the mica-containing sheets or papers, in one preferred method, a mixture of the desired amounts of mica and fibrous material is combined in water to make an aqueous dispersion; and then this mica-containing aqueous dispersion is then used to make the mica-containing nonwoven sheets by a suitable nonwoven process. For one specific example, to make a mica-containing aramid paper, mica, MPD-I fibrids, and MPD-I floc in the amounts previously mentioned herein, are combined in water to form a mica-containing aqueous dispersion suitable as a furnish for papermaking. The mica-containing dispersion is then supplied to the headbox of a papermaking machine and a wet laid web is formed. The speed of the paper machine is controlled to provide the desired thickness of the wet laid web. The wet laid web is then dried to form an unconsolidated mica-containing aramid formed web or layer, which can be further consolidated by calendering or can be combined with other like formed web(s) and then consolidated by calendering.

A nonexhaustive list of mica types that may be used for the present invention includes: muscovite, phlogopite, fluorophlogopite, and synthetic mica.

The acrylate resin is obtained following condensation between a hydroxylated resin and an acrylic or methacrylic acid. The acrylate resin is preferably diluted in a reactive acrylate solvent and in an unreactive organic solvent, for example methyl ethyl ketone, in order to lower its viscosity in application and to promote the penetration of the coating into the aramid paper. In this manner, the aramid/mica paper is compacted deep down and the detachment and shedding of the mica in the subsequent processing steps are hindered.

The polymerization of the coating resin is induced after the coating layer has been applied to the aramid/mica sheet and after the coating has penetrated into the aramid/mica sheet. In particular, polymerization of the coating resin is induced by the addition of a photoinitiator and exposure to UV light, preferably with a wavelength in the range between 200 nm and 400 nm.

Nonlimiting examples of photoinitiators used in the present invention include Omnirad TPO-L, 2-hydroxy-2-methyl-1-phenylpropanone, diphenyl-2,4,6-trimethylbenzoylphosphine oxide (TPO), phosphine oxide (BAPO), phenylbis(2,4,6-trimethylbenzoyl)phosphine oxide (BAPO), 1-hydroxycyclohexyl phenyl ketone (HCPK), 2-hydroxy-2-methyl-1-phenyl-1-propanone (HMPP), or the photoinitiators belonging to the class of bi-acylphosphate oxide polymers (TPO), or the photoinitiators belonging to the class of α-hydroxy ketones.

In a preferred configuration, the insulating sheet 10 may be used for insulating rotating or static components of electrical machines.

In a further preferred configuration, the insulating sheet 10 may be used as an outer layer on one or both sides of a composite laminate of plastic film layers, and said laminate may be used for insulating rotating or static components of electrical machines. In a further preferred configuration, one or more insulating sheets 10 may be used to form a multilayer laminate, in which the laminate comprises a plurality of plastic film layers laminated together, preferably alternating with layers of aramid paper, and the laminate may be used for insulating rotating or static components of electrical machines.

The insulating sheet 10 or the laminates described above may be used, in rotating electrical machines, for insulation of the stator slots, for closing same, and also for separating phases on the head of windings; in static electrical machines, they may be used as interlayer insulators.

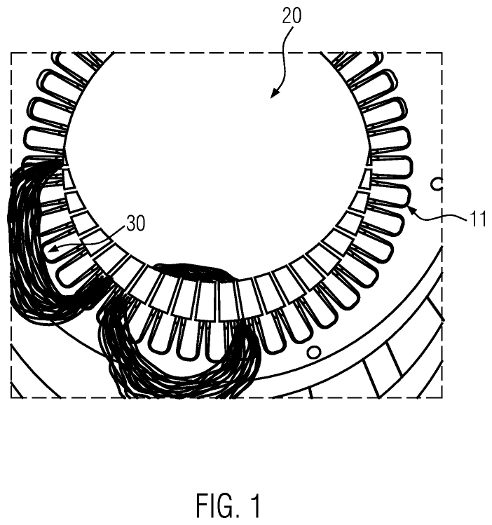

For example, FIG. 1 shows a suitably sized insulating sheet 11 used for insulating the stator 20 slot of an electric motor. Preferably, aramid/mica insulating sheets 11, impregnated with resin, are cut into segments essentially equal in length to the depth of the stator 20 and equal in width to the development of the slot to be insulated. The insulating sheet 11 may advantageously be inserted into the grooves of stator 20 of an electric motor by pushing it using a presser. The function of the insulating sheet 11 is “secondary insulation”: the current passes through the copper winding 30, which already has its own primary insulation, while the slot insulating sheet 11 contributes toward separating the magnetic sheet metal from the copper winding 30.

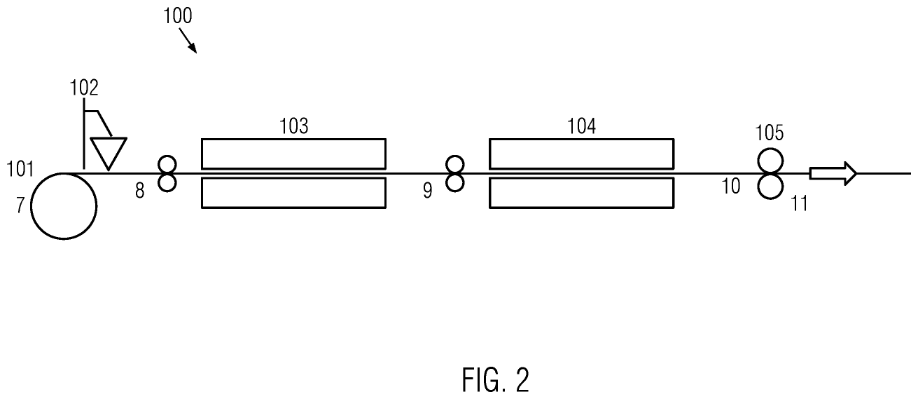

The process for producing aramid/mica insulating sheets impregnated with a coating layer is described with reference to FIG. 2.

Preformed aramid/mica backing sheets 7 are preferably supplied in reels, having, for example, a width equal to 1 m and a length of between 100 m and 2000 m. The backing sheets 7 may be, for example, DuPont™ Nomex® 818 sheets, such as those described in the document “DuPont™ Nomex® 818, Technical Data Sheet, @ Copyright 2016 DuPont.” The backing sheets 7 may include, for example, an amount of mica equal to 50% of the total composition.

The acrylate resin coating is applied onto the preformed aramid/mica backing sheets 7 by means of a “roll to roll” process schematically illustrated in FIG. 2.

An unwinder 101 supplies the production line 100 with an aramid/mica backing reel 7. A liquid formulation is prepared comprising a resin based on acrylate monomers and acrylate oligomers, for example an unsaturated polyester imide resin, to which a UV polymerization photoinitiator is added, for example Omnirad TPO-L or 2-hydroxy-2-methyl-1-phenylpropanone, and an unreactive organic solvent, for example methyl ethyl ketone (MEK), to lower the viscosity of the resin itself and to allow better penetration of the resin into the aramid paper matrix. Said liquid formulation is applied onto one of the surfaces of the aramid/mica backing sheet 7 at the application station 102, thus producing an impregnated aramid/mica sheet 8, i.e. a sheet further comprising the liquid formulation. Preferably, the liquid formulation is applied onto both surfaces of the backing sheet 7, for example it is first applied to one side and then to the opposite side.

The liquid formulation is applied to the aramid/mica backing sheets 7 preferably by the gravure or gravure engraved roller coating technique, or the Meyer bar technique, or impregnation using Foulard machines. In the configuration with coating by gravure engraved roller, the liquid formulation is initially collected in the cavities of the engraved roller and is subsequently transferred onto the aramid/mica backing sheet 7. The amount of liquid formulation applied depends on the depth of the cells of the gravure engraved roller. For example, it is possible to apply an amount of liquid formulation in the range between 10 g and 20 g per square meter of backing sheet 7, where the liquid formulation comprises a solution containing between 10% by weight and 50% by weight of acrylate resin in an unreactive organic solvent, so as to obtain a dry deposit of acrylate resin of between 1 g and 10 g per square meter of backing sheet 7 and to reach an impregnation depth of between 5 μm and 50 μm.

After application of the liquid formulation, the impregnated sheet 8 reaches the heating station 103 comprising an industrial oven, where the unreactive organic solvent is evaporated off. For example, the impregnated sheet 8 is heated to a temperature in the range between 90° C. and 120°° C. to evaporate off the solvent part and to dry the coating. At the end of the heating process, a sheet 9 is obtained in which the unreactive organic solvent has evaporated off.

The sheet 9 then reaches the UV irradiation station 104, where it is exposed to radiation emitted by an ultraviolet lamp. In particular, the UV radiation is focused on a substrate onto which a liquid formulation containing the photoinitiator has been applied. As a result of the UV light irradiation, free radicals are generated which interact with the acrylate resin that has penetrated into the sheet and induce polymerization of the formulation, which changes from liquid to solid. At the end of the UV exposure, an insulating sheet 10 is thus obtained in which the acrylate-based impregnating resin is polymerized.

Preferably, the operations of liquid formulation application, organic solvent evaporation and UV irradiation are repeated for the opposite side of the insulating sheet 10. For example, the insulating sheet 10 comprising a resin-impregnated surface can be returned to the application station 102, where the liquid formulation is applied to the opposite surface, and then it can be passed once again through the heating station 103 and the UV irradiation station 104.

Finally, the insulation sheet 10 is cut into smaller sheets, from which individual pieces of insulation 11 are made. Preferably, the insulating sheet 10 is cut into reels with a width equal to the development of the stator slot, for example with a width of between 1 cm and 10 cm.

Although the present invention has been described with reference to the embodiments described above, it is clear to a person skilled in the art that various modifications, variations and improvements of the present invention in light of the teaching described above and within the scope of the appended claims are possible without departing from the subject matter and the scope of protection of the invention.

For example, although it has been described that the crystalline silicate mineral powder comprises mica, it is clear that there may be other crystalline silicate mineral powders, for example including vermiculite, calcined clay, silica, talc, wollastonite, and/or combinations thereof. For example, each of the listed powders may be used with aramid fibers as a reinforcing element.

For example, although it has been described that the nonwoven sheet is preferably a paper structure comprising aramid fibers, it is clear that there may be different types of fibers, for example, glass fibers, a mixed aramid paper, or a film of polyamide-imide, polyester, polyimide ether, polyether ketone, polyether sulfone, polysulfide, polyimide, or the like. For example, each of the indicated reinforcing elements may be used to contain mica as a crystalline silicate mineral powder.

Finally, those areas considered to be known to experts in the field have not been described to avoid unnecessarily overshadowing the described invention.

For example, the process of gravure coating, or gravure engraved roller coating, Meyer bar, or Foulard machine impregnation have not been described in detail since they are considered to be known to those skilled in the art.

For example, the process of deposition and polymerization of the impregnating resin on an aramid/mica paper by means of a “roll to roll” process has not been described in detail, as it is considered to be known to those skilled in the art.

Accordingly, the invention is not limited to the embodiments described above, but is only limited by the scope of protection of the appended claims.

### REFERENCE NUMBERS

7: backing sheet
8: sheet impregnated with resin
9: sheet from which the unreactive organic solvent is evaporated
10: insulating sheet
11: cut insulating sheet
20: stator slot
30: copper winding
100: coating roll-to-roll deposition and polymerization station
101: unwinder
102: liquid formulation application station
103: heating station
104: UV irradiation station
105: cutting station

1. An insulating sheet comprising a nonwoven sheet containing a crystalline silicate mineral powder,
characterized in that:
said insulating sheet also comprises a coating of an impregnating resin based on acrylate derivatives.

2. The insulating sheet according to claim 1, wherein said nonwoven sheet contains 15 to 80 percent by weight of the crystalline silicate mineral powder.

3. The insulating sheet according to claim 1, in which said crystalline silicate mineral powder comprises mica.

4. The insulating sheet according to claim 1, wherein the nonwoven sheet has a first surface and a second surface, the nonwoven sheet comprising 15 to 80 weight percent crystalline silicate mineral powder, 5 to 25 weight percent heat-resistant floc, and 20 to 60 weight percent binder, based on the total amount of said crystalline silicate mineral powder, floc, and binder in the nonwoven sheet,
wherein each of the first and second surfaces of the nonwoven sheet are coated with the impregnating resin, and each of the first and second surfaces are stabilized by a region of the said impregnating resin that both covers and extends into each of said first and second surfaces,
the region of impregnating resin extending into the sheet a distance of 10 to 50 micrometers from each of said first and second surfaces, and further, the region of impregnating resin having a thickness of impregnating resin of from 5 to 50 micrometers on each of said first and second surfaces.

5. The insulating sheet according to claim 3 wherein the nonwoven sheet comprises 20 to 70 weight percent mica.

6. The insulating sheet according to claim 4 wherein the heat-resistant floc is aramid floc.

7. The insulating sheet according to claim 4 wherein the binder includes aramid fibrids.

8. The insulating sheet as claimed in claim 1, in which said coating of impregnating resin comprises an unsaturated polyester imide material.

9. The insulating sheet as claimed in claim 1, in which said impregnating resin also comprises a polymerization photoinitiator.

10. A method for producing an insulating sheet, comprising the following steps:
a) providing a nonwoven backing sheet comprising a crystalline silicate mineral powder;
characterized in that
said method also comprises the following step:
b) depositing a coating layer of an impregnating resin based on acrylate derivatives onto said nonwoven backing sheet so as to obtain a resin-impregnated sheet.

11. The method according to claim 10, wherein said nonwoven backing sheet comprises 15 to 80 percent by weight of the crystalline silicate mineral powder.

12. The method as claimed in claim 10, wherein the nonwoven backing sheet has a first surface and a second surface, the nonwoven backing sheet comprising 15 to 80 weight percent crystalline silicate mineral powder, 5 to 25 weight percent heat-resistant floc, and 20 to 60 weight percent binder, based on the total amount of said crystalline silicate mineral powder, floc, and binder in the nonwoven backing sheet, and
wherein the coating layer of impregnating resin is deposited on each of the first and second surfaces of the nonwoven backing sheet,
the coating layer providing a region of the said impregnating resin that both covers and extends into each of said first and second surfaces,
the region of impregnating resin extending into the nonwoven backing sheet a distance of 10 to 50 micrometers from each of said first and second surfaces, and further, the region of impregnating resin having a thickness of impregnating resin of from 5 to 50 micrometers on each of said first and second surfaces.

13. The method as claimed in claim 10 wherein the nonwoven backing sheet comprises 20 to 70 weight percent mica.

14. The method as claimed in claim 12 wherein the heat-resistant floc is aramid floc.

15. The method as claimed in claim 12 wherein the binder includes aramid fibrids.

16. The method as claimed in claim 10, in which said coating layer comprises an unsaturated polyester imide material.

17. The method as claimed in claim 10, in which said coating layer comprises an organic solvent and said method also comprises the following step:
c) evaporation of said organic solvent by drying said resin-impregnated sheet.

18. The method as claimed in claim 10, in which said impregnating resin also comprises a polymerization photoinitiator, and in which said method also comprises the following step:
d) exposing said resin-impregnated sheet to UV radiation so as to bring about the polymerization of said coating layer.

19. The method according to claim 10, wherein said impregnating resin based on acrylate derivatives has a viscosity comprised between 5 cps and 150 cps.

20. A laminate comprising at least one insulating sheet as claimed in claim 1 and at least one layer of plastic film, in which said insulating sheet is laminated on one side of said layer of plastic film, preferably so as to form the outer side of said laminate.

21. The laminate as claimed in claim 20, comprising a plurality of said insulating sheets and a plurality of said layers of plastic film, in which said insulating sheets are alternated with said layers of plastic film, preferably so as to form the outer side of said laminate.

22. An electric motor comprising one or more insulating sheets as claimed in claim 1.
